(19) United States
(12) Patent Application Publication
(10) Pub. No.: US 2008/0172133 A1
(43) Pub. Date: Jul. 17, 2008

(54) SYSTEM AND METHOD FOR CONTROLLING ACCESS TO THE GAS SUPPLY OF A STOVE

(76) Inventor: Meir Avigdor, Brooklyn, NY (US)

Correspondence Address: Avi Outmezguine, 238 6th avenue, apt. 2, brooklyn, NY, 11215, US

(21) Appl. No.: 11/624,188

(22) Filed: Jan. 17, 2007

(51) Int. Cl. G05B 15/02

(52) U.S. Cl. 700/9

(57) ABSTRACT

Disclosed is a system and method for controlling access to the gas supply of a stove and other similar appliances which utilize lit gas as a heat source. The present invention consists of a control device which controls a valve which can enable or disable the gas line to a stove. The control device consists of a keypad and a digital display. To use the device, a user first enters a PIN or other code into the control device. If the code is correct, the user is allowed to set a time limit for which the valve will allow gas to flow from the input gas line to the stove. After the expiration of the timer on the control device, the valve automatically stops the flow of gas from the input gas line to the stove. This has the effect of only allowing a person with the correct access code the ability to utilize the stove. Thus, small children and other unauthorized users cannot gain access to the stove or accidentally turn it on.

### BACKGROUND OF THE INVENTION

Many homes are equipped with ovens and/or ranges which utilize a gas supply for heat. To operate these devices, a user usually only has to turn a knob on the front of the device to the desired temperature or flame level. This, however, may potentially be dangerous when children are present because there is no way to control access to the appliances. This can lead to serious burns and other injuries to young children not familiar with the operation of a stove.

Therefore, there clearly exists a need for a device which restricts access to an oven and/or range. More particularly, there exists a need to control the gas supply to cooking appliances because restricting the gas supply will restrict access to the entire cooking appliance.

### SUMMARY OF THE INVENTION

The present invention discloses a system and method for controlling access to the gas supply of a stove and other similar appliances which utilize lit gas as a heat source. The present invention consists of a control device which controls a valve which can enable or disable the gas line to a stove. The control device consists of a keypad and a digital display. To use the device, a user first enters a PIN or other code into the control device. If the code is correct, the user is allowed to set a time limit for which the valve will allow gas to flow from the input gas line to the stove. After the expiration of the timer on the control device, the valve automatically stops the flow of gas from the input gas line to the stove. This has the effect of only allowing a person with the correct access code the ability to utilize the stove. Thus, small children and other unauthorized users cannot gain access to the stove or accidentally turn it on.

The control device and the valve can either be manufactured as part of the oven (e.g., as a feature of the oven) or added to a pre-existing stove. It should be obvious to one skilled in the art how the device of the present invention can be adapted for either situation.

Other objects, features, and characteristics of the present invention, as well as the methods of operation and functions of the related elements of the structure, and the combination of parts and economics of manufacture, will become more apparent upon consideration of the following detailed description with reference to the accompanying drawings, all of which form a part of this application.

### BRIEF DESCRIPTION OF THE DRAWINGS

For a more complete understanding of the present invention, reference is now made to the following drawings in which:

FIG. 1 depicts a schematic diagram showing the present invention integrated into a cooking appliance.

### DETAILED DESCRIPTION

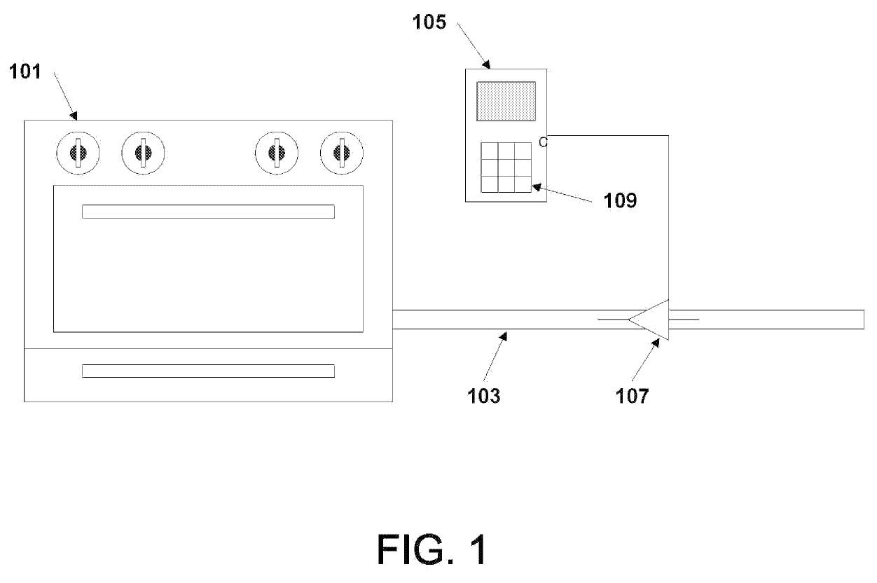

Referring first to FIG. 1, shown is the device of the present invention integrated into a standard cooking appliance 101 which receives its gas supply from pipe 103. Control device 105 is connected to valve 107. Valve 107 is capable of completely restricting the gas supply to cooking appliance 101. To use the device, a user first enters a PIN or other code into control device 105 utilizing keypad 109. If the code is correct, the user is allowed to set a time limit for which valve 107 will allow gas to flow to cooking appliance 101. After the expiration of the timer, valve 107 automatically stops the flow of gas from. This has the effect of only allowing a person with the correct access code the ability to utilize the stove. Thus, small children and other unauthorized users cannot gain access to the stove or accidentally turn it on.

Control device 105 and valve 107 can either be manufactured as part of cooking appliance 101 (e.g., as a feature of the oven) or added post-manufacture. It should be obvious to one skilled in the art how the device of the present invention can be adapted for either situation.

While the present invention has been described with reference to one or more preferred embodiments, which embodiments have been set forth in considerable detail for the purpose of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

1. An apparatus for controlling the supply of gas to a cooking device comprising:
a flow valve dispersed between the gas supply of said cooking device and said cooking device; and
a control device with a keypad capable of controlling the operation of said valve, wherein a user of said control device is able to input a personal identification number into said control device to set a time to control said valve.
